(19) United States
(12) Patent Application Publication
(10) Pub. No.: US 2015/0047248 A1
(43) Pub. Date: Feb. 19, 2015

(54) WEED DEFLECTOR AND SYSTEM FOR USE WITH FISHING HOOKS AND LURES

(71) Applicant: ARC9, LLC., Middleton, WI (US)

(72) Inventors: Alec R. Riddle, Middleton, WI (US); Raymond T. Riddle, Middleton, WI (US)

(21) Appl. No.: 14/454,016

(22) Filed: Aug. 7, 2014

Related U.S. Application Data
(60) Provisional application No. 61/865,853, filed on Aug. 14, 2013.

(51) Int. Cl. A01K 85/02

(52) U.S. Cl. CPC A01K 85/02
USPC 43/43.1

(57) ABSTRACT

A weed deflector for protection of a fishing lure is attached directly to a fishing line and is able to move about freely. The weed deflector may rest on top of the lure or partially engage the lure, and may be used with substantially any existing lure. The weed deflector may come in a variety of shapes, including circular or polygonal, and may be manufactured from a variety of materials, including plastic or metal, in an alternate embodiment, the weed deflector has projections off its base to attract fish to the lure.

### CROSS REFERENCE TO RELATED APPLICATIONS

This application claims priority from U.S. Provisional Patent Application Ser. No. 61/865,853, filed on Aug. 14, 2013, the contents of which are herein incorporated by reference in their entirety.

### BACKGROUND OF THE INVENTION

The present invention relates to the general field of fishing accessories and more particularly to fishing accessories to prevent debris from accumulating on lures while fishing.

Fishing continues to enjoy popularity as both a hobby and a sport. Today's fishermen have the ability to choose from a wide variety of rods, lures, and lines, such that they are able to select a combination that is particularly tailored to the type of fish being sought and the body of water being fished in.

Regardless of where a fisherman chooses to cast his line, the probability of the water containing some type of weed, vegetation, or other type of debris is great. As a result, when moving one's lure in the water, by, for example, trolling, the fisherman risks getting weeds or debris caught on and entangled with his lure. He is then required to pull his lure in and manually remove the entangled material before being able to resume casting.

One solution to this problem was the creation of weed guards designed to protect a lure from passing weeds or debris. Such weed guards may attach to the shank of the hook and extend over the hook barb to protect it from weeds as the hook is pulled through the water in the manner of an umbrella. The operation of such weed guards requires that the weed guard extend substantial portion of the lure's shaft, thereby concealing the lure from passing fish. For this reason, the guard must be configured to be as attractive as a lower itself, something that may not be consistent with its function of protecting the hook against weeds. Further, the guard itself may interfere with the operation of the hook blocking not only leads but fish from the hook barb. A fisherman who uses multiple types of lure and desires protection for each type is required to purchase a separate lure with attached weed guard for each variety.

### SUMMARY OF THE INVENTION

The present inventors have determined that a relatively small deflector placed in front of the hook can create a water flow pattern that shields the hook from entanglement with weeds without blocking the hook itself or substantially obscuring the lure. The ability to mount the deflector further upstream from the hook also allows it to be a separate item from the hook allowing a single deflector to be used for multiple different hooks and lures by simply attaching it to the line.

Specifically then, the present invention provides a weed deflector system for a fishing lure, the weed deflector including a hook having an extentuate shank portion terminating at a front end in an eye and at a rear end at a bend terminating at a point and barb. A fishing line is attached to the eye and extends therefrom. A shield body expands in two dimensions from a frontmost apex toward a rear lip and includes a line attachment feature at the apex of the conical shield body attaching the fishing line along a vertical the axis to be retained substantially centered on the fishing line in front of a hook attached to an end of the fishing line to present minimized water resistance when the hook is drawn through the water and to deflect weeds around the hook.

It is thus a feature of at least one embodiment of the invention to provide a weed deflector that can work with a wide variety of lures and hooks by being attached to the line rather than the hook itself is another feature of at least one embodiment of the invention to provide a weed deflector shield body that provides some flexure with respect to the hook to prevent interference with hook systems that require freedom of motion.

The line attachment feature may be a hole slidably engagable with the fishing line.

It is thus a feature of at least one embodiment of the invention to allow simple engagement of the shield body with the line at any point along the line while allowing it to slide into abutment with the hook.

The hole may be sized to slide over the line but prevent passage by the eye on the hook therethrough.

It is thus a feature of at least one embodiment of the invention to make use of the eye of the hook as a natural stop for the shield body.

The rear lip of the shield body may terminates along the axis to cover less than half the shank when the shank is oriented along the axis substantially all of the lure is exposed.

It is thus a feature of at least one embodiment of the invention to provide a deflector system that does not interfere with the visibility or usability of the wide variety of hooks and lures.

The conical body may terminate at a radial distance from the axis no less than the gape of the hook.

It is thus a feature of at least one embodiment of the invention to displace weeds away from the hook barb.

These particular features and advantages may apply to only some embodiments falling within the claims and thus do not define the scope of the invention.

### BRIEF DESCRIPTION OF THE DRAWINGS

FIG. 1 is a front plan view of a weed deflector system according to one embodiment of the invention.

FIG. 2 is a front plan view of a weed deflector system according to one embodiment of the invention.

FIG. 3a is a front plan view of a weed deflector according to one embodiment of the invention.

FIG. 3b is a front plan view of a weed deflector according to one embodiment of the invention.

FIG. 3e is a top view of a weed deflector according to one embodiment of the invention.

FIG. 3d is a top view of a weed deflector according to one embodiment of the invention.

FIG. 4a is a top view of a weed deflector according to one embodiment of the invention.

FIG. 4b is a top view of a weed deflector according to one embodiment of the invention.

FIG. 5a is a top view of a weed deflector according to one embodiment of the invention.

FIG. 5b is a top view of a weed deflector according to one embodiment of the invention.

FIG. 6 is a front plan view of a weed deflector with a ridge at the base according to one embodiment of the invention.

FIG. 7 is a front plan view of a weed deflector with fringe at the base according to one embodiment of the invention.

FIG. 8 is front plan view of a weed deflector with tassels at the base according to one embodiment of the invention.

FIG. 9 is a front plan view of a weed deflector with points at the base according to one embodiment of the invention.

### DETAILED DESCRIPTION OF THE INVENTION

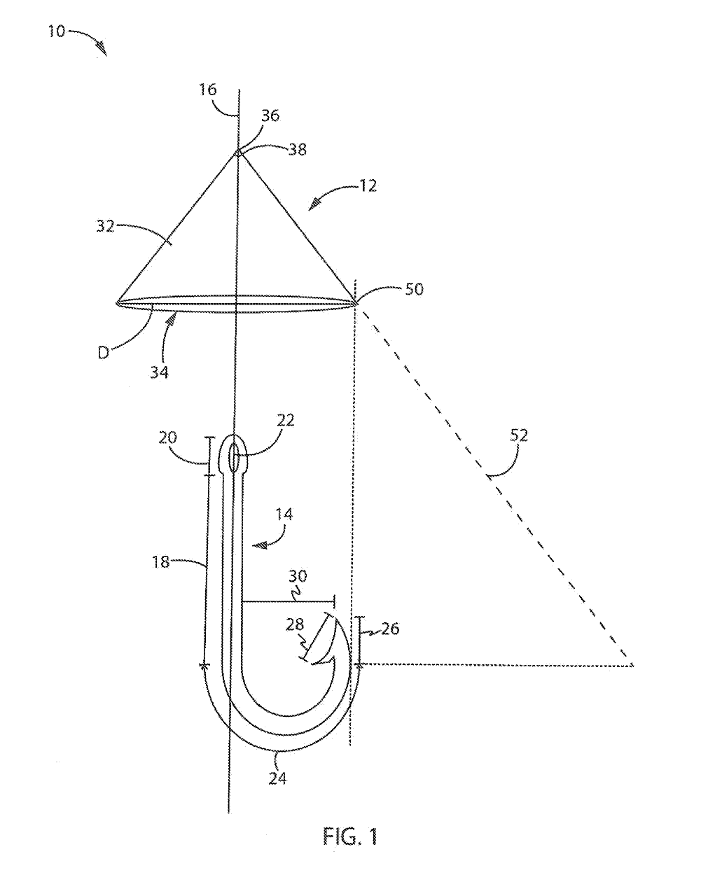

Referring to FIG. 1, a preferred embodiment of a weed deflector system 10 according to the present invention is shown. The system 10 consists of a weed deflector 12 and a lure 14 both connected to a fishing line 16 along an assembly axis.

In this embodiment, the lure 14 comprises a hook, which may be combined with a variety of baits and/or accessories. The hook includes a shank 18 presenting as a substantially straight wire running substantially parallel to the linear axis. The shank 18 is attachable to the fishing line 16 by means of an eye 20 at the top end of the shank 18, wherein the eye 20 is formed by folding the top of the shank 18 in a circular direction to create an enclosed opening 22 through which fishing line 16 may be passed. The distal end of the shank 18 features a bend 24, directed away from the linear axis and forming a U-shape. The bend 24 culminates in a point 26, from which extends a barb 28. The barb 28 extends at an angle away from the point 26 and in a reverse direction from the point 26. The point 26 is separated from the shank 18 by a gape 30.

The weed deflector 12 has a shield body 32 that is substantially conical in shape and terminates at a base 34 of diameter a The walls of the shield body 32 are thin, such that the body 32 is hollow. The conical body 32 terminates at an apex 36 located opposite the base 34 along a linear axis. The shield body 32 may be made of a variety of different sheet materials rolled or formed into a cone or may be injection molded as a thin-walled plastic element. In a preferred embodiment, the weed deflector 12 is made of a plastic or plastic film. Other suitable materials include silicone alloys, magnesium alloys, coated paper products, lead, iron, steel, and brass. Ideally this material will be water resistant. Preferably, the shield body 32 may be a neutral or negative buoyancy so as to allow entire assembly to he fully submerged in the water. The shield body 32 may be smooth or textured and may be plain or contain a design.

The apex 36 includes an opening 38 through which fishing line 16 is able to pass but sized to prevent the lure 14 from passing through the opening. As the base 34 is substantially hollow, the fishing line 16 passes directly from the opening 38 in the apex 36 through the base 34 where it is then able to be connected to the lure 14 at the eye 20. Once attached in such a manner, the weed deflector 12 remains threaded on the fishing line 16, and may move freely about the fishing line 16. This movement includes axial movement along the line as well as some slight movement in angle relative to the assembly axis allowing the shield body to deflect slightly and avoid fallowing in the weeds itself

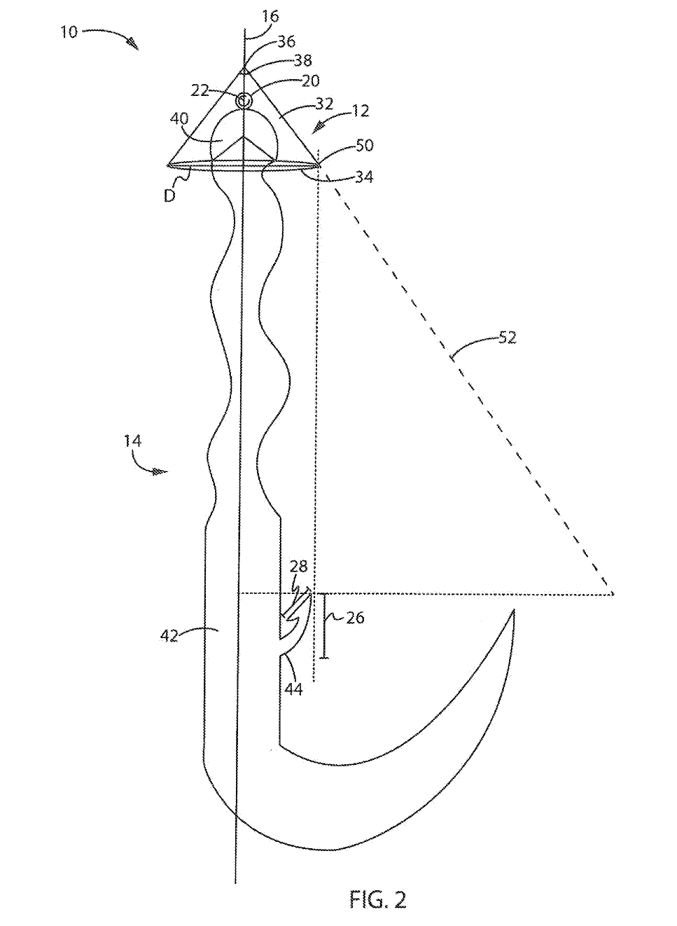

FIG. 2 shows an additional embodiment of the weed deflector system 10 according to the present invention, wherein the lure 14 being used is a jig lure. The jig lure consists of a jig head 40, typically manufactured from molded metal, with an attached eye 20 at a point on the head 40. The eye 20 is essentially an enclosed opening 22 to facilitate attachment of a fishing line 16. Opposite the eye 20 is a flexible jig body 42, manufactured generally from rubber or silicone. The flexible jig body 42 may take many shapes, as is well known in the art. Protruding from the flexible jig body 42 at a point near the distal end is a lure hook 44. The lure hook 44 projects from the flexible jig body 42 at an angle to the linear axis, culminating in a point 26 from which extends a barb 28. As in FIG. 1, the weed deflector 12 has a substantially conical body 32 with an apex 36 and a substantially open base 34 with a diameter D. FIG. 2 illustrates the weed deflector 12 positioned at a point along the linear axis such that the conical body 32 has engaged the jig head 40 and the eye 20 at the apex 36.

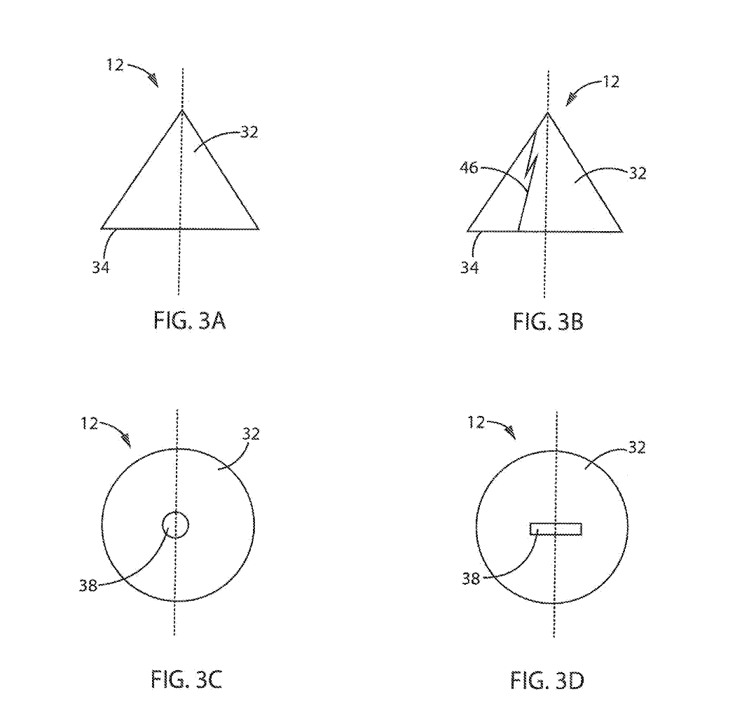

Turning to FIGS. 3a and 3b, two embodiments of the conical body 32 of the weed deflector 12 are shown. FIG. 3a illustrates a weed deflector 12 in which the conical body 32 has no openings. FIG. 3b shows a weed deflector 12 wherein the conical body 32 includes a slit 46. The slit 46 has a width of not less than 0.010 inches and not more than 0.050 inches. As a majority of commercial fishing line has a diameter of between 0.010 inches and 0.050 inches, the slit 46 allows the weed deflector 12 to be removed and replaced on a fishing line 16 without requiring the user to rethread the fishing line 16 through the weed deflector 12 and retie the fishing line 16 to the lure 14. As a result, a single weed deflector 12 may be transferred between different lines quickly and easily.

FIGS. 3c and 3d illustrate two potential shapes of the opening 38 found at the apex 36. The opening 38 may be substantially circular in form, as seen in FIG. 3c, which allows the eye 20 of the lure 14 to rest against the weed deflector 12 during use. The opening 38 may also be rectangular, as seen in FIG. 3d. A rectangular opening 38 may allow at least a portion of the eye 20 of the lure 14 to engage with the weed deflector 12 as seen in FIG. 2.

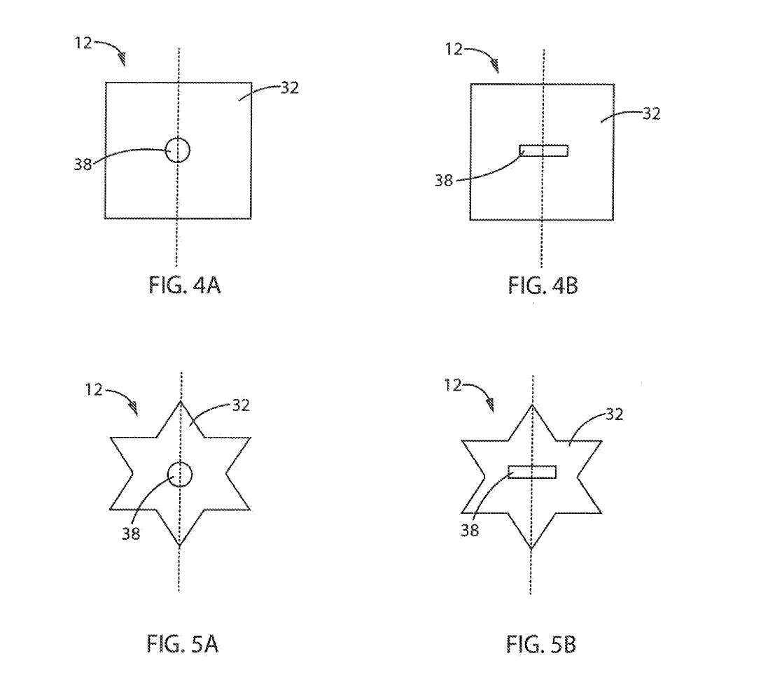

Although the preferred embodiment of the weed deflector 12 is a substantially circular cone, other geometries may be used. The base 34 of the weed deflector 12 may be shaped according to any polygon. FIGS. 4a and 4b illustrate an embodiment of the weed deflector 12 with a square base 34, resulting in a substantially square conical body 32 FIGS. 5a and 5b illustrate a further embodiment of the weed deflector 12, wherein the base 34 is star shaped, resulting in a substantially star shaped conical body 32. As in other embodiments of the weed deflector 12, the apex 36 features an opening 38, which may be circular or rectangular in shape.

Returning to FIG. 1, the body 32 of the weed deflector 12 extends from the apex 36 at an angle 48 with respect to a vertical axis. Preferably, angle 48 is not less than 10° and not more than 80°. The base 34 of the weed deflector 12 has a diameter D. Preferably, D is not less than 0.125 inches and not greater than 6.00 inches. Importantly, the endpoint 50 of the weed deflector 12 is substantially aligned along the same vertical axis as the point 26 of the lure 14, thus allowing the barb 28 of the lure 14 to remain visible to fish at all times.

In operation, the weed deflector system 10 functions to prevent weeds and similar vegetation or debris from collecting on the lure 14. As the lure 14 is moved in the water, the weed deflector 12 will be inclined to move along the fishing line 16 towards the eye 20 of the lure 14. The conical body 32 deflects passing weeds and prevents them from becoming entangled with the lure 14. In a preferred embodiment, a diagonal projection 52 of the conical body 32 extends past the body of the lure 14 by a minimum of 0.500 inches. This ensures that weeds, having been redirected by the weed deflector 12, will remain well away from the lure 14 after they are no longer in contact with the weed deflector 12, while still keeping the endpoint 50 of the weed deflector 12 substantially aligned with the barb 28 of the lure 14

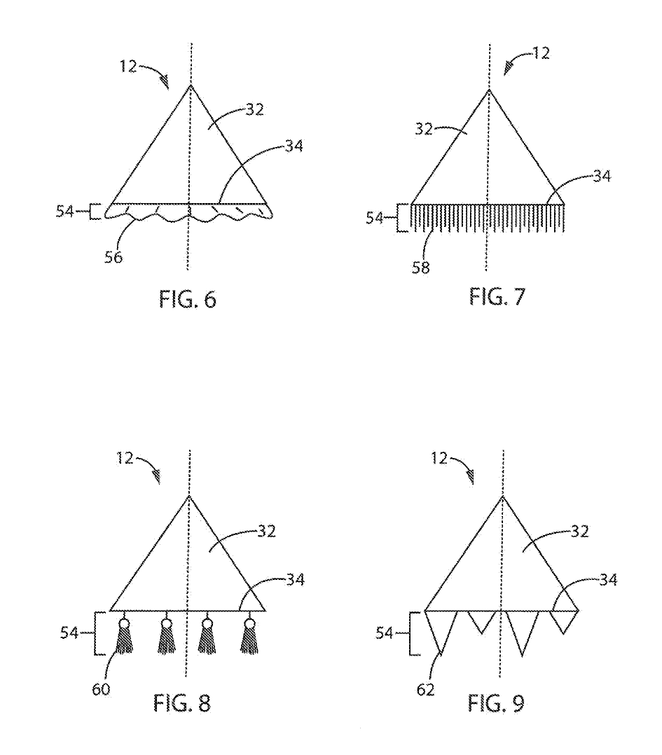

In one embodiment, the base 34 of the weed deflector 12 contains a protrusion 54. The protrusion 54 serves to attract fish to the lure 14 while maintaining the deflection properties of the weed deflector 12. The protrusion 54 may take one of many forms, such as a ridge 56 as shown in FIG. 6, fringe 58 as shown in FIG. 7, tassels 60 as shown in FIG. 8, or points 62 as shown in FIG. 9, and would be of sufficient length to be attractive to a fish while continuing to allow the barb 28 of the lure 14 to remain unimpeded and visible to the fish. Alternately, the protrusion 54 may be directed inward from the base 34, such that it causes the base 34 to feature a groove or indentation. For example, ridge 56 of FIG. 6 may be understood to cause the base to have a series of indentations. In either embodiment, the protrusions 54 may cause the weed deflector 12 to move erratically in the water, serving as an additional point of attraction for a fish.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended, to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following chums. All of the publications described herein, including patents and non-patent publications, are hereby incorporated herein by reference in their entireties.

1. A weed deflector system for a fishing lure, the weed deflector system comprising:
a hook comprising an extentuate shank portion terminating at a front end in an eye and at a rear end at a bend terminating at a point and barb;
a fishing line attached to the eye and extending therefrom;
a shield body expanding in two dimensions from a frontmost apex toward a rear lip along an axis, and
a line attachment feature at the apex of the shield body attaching the fishing line to extend along the axis and to be retained substantially centered on the fishing line in front of a hook attached to an end of the fishing line to present minimized water resistance when the hook is drawn through the water and to deflect weeds around the hook.

2. The weed deflector of claim 1, wherein the line attachment feature is a hole slidably engagable with the fishing line.

3. The weed deflector of claim 2 wherein the hole is sized to slide over the line but prevent passage by the eye on the hook therethrough.

4. The weed deflector system of claim 1, wherein conical body terminates at a radial distance from the axis substantially equal to a gape of the hook.

5. The weed deflector system of claim 4, wherein the rear lip terminates along the axis to cover less than half the shank when the shank is oriented along the axis.

6. The weed deflector of claim 1, wherein the shield body is a cone having circular base.

7. The weed deflector of claim 1, wherein the shield body has a polygonal base.

8. The weed deflector of claim 1, wherein the rear lip diameter of the shield body is between 0.125 inches and 6.00 inches.

9. The weed deflector of claim 1, wherein an angle from the apex to the rear lip in a plane along the axis is between 10° and 80°.

10. The weed deflector of claim 1, wherein the diagonal projection of the shield body extends past the hook by at least 0.500 inches.

11. The weed deflector of claim 1, wherein a side of the shield body contains a slit from the apex to the lip to allow for removal and reattachment of the shield body to a fishing line.

12. The weed deflector of claim 11, wherein the slit has a width of between 0.010 inches and 0.050 inches.

13. The weed deflector of claim 1, wherein the deflector is made from one of plastic, plastic film, silicone aluminum alloy, magiesium allow, coated paper product, lead, iron, steel, brass and ceramic.

14. The weed deflector of claim 1, wherein the deflector includes at least one projection from its base and wherein at least one projection may be a ridge, fringe, tassels, or point.

15. The weed deflector of claim 1, wherein the deflector includes at least one indentation from its base and wherein at least one indentation may be a groove or dimple.
